(19) United States
(12) Patent Application Publication
(10) Pub. No.: US 2025/0371316 A1
(43) Pub. Date: Dec. 4, 2025

(54) DATA ANOMALY DETECTION USING A LARGE LANGUAGE MODEL

(71) Applicant: Pinterest, Inc., San Francisco, CA (US)

(72) Inventors: Isabel Tallam, Los Altos, CA (US); Kapil Bajaj, Fremont, CA (US)

(73) Assignee: Pinterest, Inc., San Francisco, CA (US)

(21) Appl. No.: 18/733,410

(22) Filed: Jun. 4, 2024

(51) Int. Cl. G06N 3/0455

(52) U.S. Cl. CPC G06N 3/0455

(57) ABSTRACT

Disclosed are systems and methods that process a dataset to determine data anomalies in the dataset. The process may receive a query to create the dataset. At least one known data anomaly may be identified in the dataset. An algorithm that models a pattern of the dataset may be selected. The dataset, known data anomaly, and/or algorithm may be sent to a Large Language Model (LLM) with instructions to determine configuration information for data anomaly detection including at least one threshold that indicates additional anomalies in the dataset. The algorithm may create a reference dataset that is compared to the dataset to determine deviations. The threshold may determine which deviations indicate additional anomalies. The LLM may send configuration data, including at least the threshold, to an anomaly detection application, which may be configured with the configuration data and used to determine data anomalies in other, similar, datasets generated with the query or a similar query.

### BACKGROUND

Many entities generate vast amounts of electronic data. Companies that provide internet-based electronic services to customers may experience millions of customer interactions, capturing data during each interaction to process requests and serve information to these customers. Data may be machine generated, user generated, or a combination of both. While a vast majority of this generated data may follow a predictable pattern, some data may be generated in response to unanticipated events, which may result in problematic data.

Problematic data may include duplicate data that may be generated as a result of a human error, a software bug, or for other reasons. For example, a computing system may store records related to customer activities, such as purchases of items. In some instances, a customer's electronic actions may be duplicated, such as when a browser sends duplicate information to a host server, possibly caused by a mistake by a user or possibly by duplication by an electronic device.

Problematic data may include data generated by malicious actors. For example, an entity may experience an increase in requests from a brute force attack on their servers that attempts to gain access to certain information, overwhelm the servers, or otherwise negatively impact the entity. Entities often prefer to learn about malicious actors and prevent them from interfering with their services.

Some data may be generated in response to unexpected events that an entity may desire to discover and understand. An electronic service may experience a spike in activity in response to occurrence of a real-life event that triggers that spike in activity. For example, when a celebrity is diagnosed with a serious medical condition, many people may use computing resources and generate an unexpected large amount of electric data by discussing this topic, researching the medical condition, and performing other electronic tasks as a result of the unexpected event.

Entities may desire to determine data anomalies resulting from some or all of these types of scenarios. Often, data anomalies are discovered using highly manual processes that rely on data analysts that interact with data. This approach is time consuming and difficult to scale to meet the needs of many entities.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a schematic diagram of an illustrative environment that includes exemplary computing devices and data processing for data anomaly detection using Large Language Models (LLMs) for implementing aspects of the disclosed subject matter.

FIG. 2 is a pictorial diagram showing exemplary data including a first dataset having a known anomaly and a second dataset to detect additional anomalies, in accordance with aspects of the disclosed subject matter.

FIG. 3 is a flow diagram illustrating an exemplary process for detecting data anomalies, in accordance with aspects of the disclosed subject matter.

FIG. 4 is a flow diagram illustrating an exemplary process for data anomaly detection using an LLM, in accordance with aspects of the disclosed subject matter.

FIG. 5 is a flow diagram illustrating an exemplary process for multi-dimensional data anomaly detection using an LLM, in accordance with aspects of the disclosed subject matter.

FIG. 6 is a flow diagram illustrating another exemplary process for data anomaly detection using an LLM, in accordance with aspects of the disclosed subject matter.

FIG. 7 is a flow diagram illustrating an exemplary process to update data anomaly detection using an LLM, in accordance with aspects of the disclosed subject matter.

FIG. 8 is a block diagram of an exemplary computing system suitably configured to implement aspects of a host service, in accordance with aspects of the disclosed subject matter.

### DETAILED DESCRIPTION

Disclosed are systems and methods that provide data anomaly detection using LLMs to provide configuration information for anomaly detection applications. A data anomaly is any unexpected data that a user may desire to investigate to determine a cause of the underlying data (e.g., why this data was generated). Data anomalies may be present due to human error, machine error, unexpected events, malicious activity, and/or for other reasons.

To determine anomalies in data, a query may be created to retrieve a dataset. The dataset may then be subject to inspection to determine data anomalies, which may be further investigated to better understand a cause for the data anomaly. The datasets may include temporal data that includes a time stamp associated with event data. For example, the data may represent occurrences of customer activities over a period of time. Time stamps may be generated at intervals, when actions occur, or at other times. Data may be queried to determine a count (quantity) of actions associated with a time stamp. For example, the data may represent a quantity of user interactions per second, minute, hour, day, or week (or any other division of time). Other data may be captured including location data, device data (e.g., a type of electronic device or operating system, etc.), and so forth.

To determine anomalies in the dataset, a reference dataset may be generated and used to determine an expected value for data in the dataset. The reference dataset may be generated using an algorithm (e.g., equation, formula, data model, etc.) that creates reference data having a similar pattern as the actual data to be inspected. For example, the algorithm may generate a reference dataset that includes a seasonal pattern, a regression pattern, a linear pattern, an exponential pattern, a weighted pattern, a random pattern, or other patterns that may be replicated by an algorithm. The algorithms may be limited to basic data models or representations to avoid overfitting the reference data to the dataset, which can sometimes occur with LLMs that are over trained to match existing data, but are then poor at predicting and forecasting future data due to the specificity of the algorithm created from the existing data. In contrast, basic data models may be used that have proven results at more accurately forecasting or predicting future data points that were not present in the training data.

The actual dataset may then be compared to the reference dataset to determine deviations. Deviations may be based at least in part on a difference between data points of corresponding time stamps from the actual dataset and the reference dataset. The deviations may be expressed as percentages, actual values, using other representations or groupings, including statistical analysis, or may be expressed in other ways.

The deviations may be analyzed to determine which deviations are likely to indicate anomalies in the actual dataset. In some instances, one or more anomaly in the actual dataset may be already known and may be provided as a known anomaly. For example, a user may inspect the actual dataset and identify a known anomaly in the actual dataset as being associated with a particular time stamp.

In various embodiments, the actual dataset, the algorithm, and the one or more known anomalies may be sent to an LLM with instructions to cause the LLM to provide thresholds and possibly other configuration data for a data anomaly detection application. The instructions may include instructions to be read by the LLM to cause the LLM to perform a requested action or series of actions. The instructions may include formatting information, examples of inputs/outputs, and/or other information, possibly written in part as natural language instructions. The LLM may determine the deviations between the actual dataset and the reference dataset generated by the algorithm. The LLM may determine thresholds to be applied to the deviations to detect additional anomalies in the dataset. For example, the thresholds may be a maximum percentage deviation or maximum value deviation that are applied to select deviations as indicating anomalies. In some instances, the thresholds may be tuned or otherwise modified or calibrated to reduce noise (e.g., false positives, etc.) such as by limiting an amount of detected anomalies to a predetermined amount (e.g., less than 10% of total data points, etc.) or by selecting the thresholds based on other factors (e.g., best fit, etc.).

In various embodiments, the instructions may request the LLM to determine the algorithm that creates the reference dataset. The LLM may also be provided with multiple algorithms, or requested to generate multiple algorithms, which may be used to create different reference datasets for data anomaly detection. When multiple algorithms are generated or used, a data anomaly module may output different anomaly detections based on the different algorithms, which may enable a data analyst to select between the algorithms, isolate variables in the dataset (e.g., data with multiple dimensions or fields of values, etc.), and so forth.

The query used to create the dataset, the algorithm(s), the threshold(s), and/or other configuration data may be used by an anomaly detection application to retrieve a new dataset and determine additional data anomalies. A data analyst may then inspect the anomalies. In some instances, the process may be repeated from time to time to update the algorithm(s), the threshold(s), or other inputs/outputs to the LLM and for the anomaly detection application. For example, as additional anomalies are detected and verified, those verified anomalies may be input into the LLM as known anomalies for use in creating new and updated algorithms and/or thresholds.

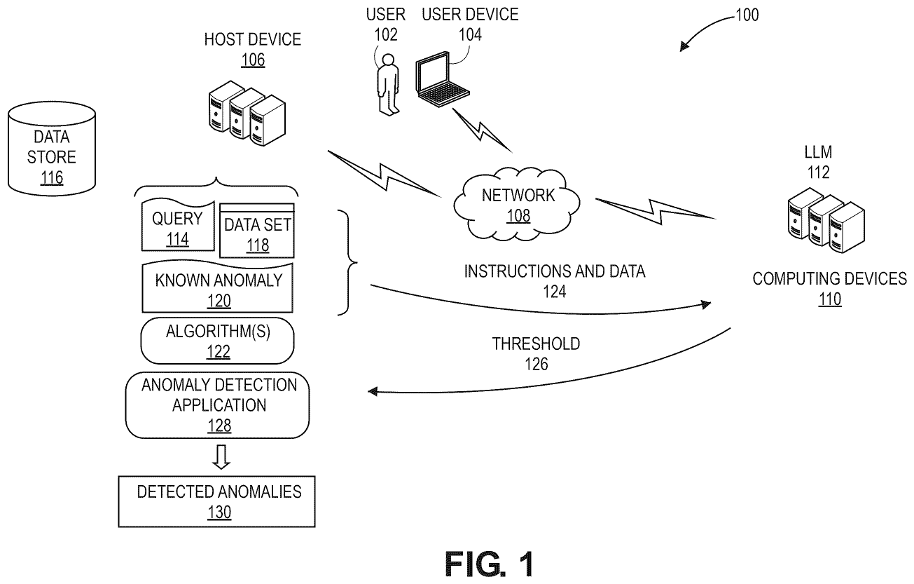

FIG. 1 is a schematic diagram of an illustrative environment 100 that includes exemplary computing devices and data processing for data anomaly detection using LLMs for implementing aspects of the disclosed subject matter. The environment 100 may include a user 102 and a user device 104 that is in communication with a host device 106 via a network 108. The user 102 may be a data analyst or person interested in discovering data anomalies. The user device 104 may include personal computers, smart phones, and/or other personal computing devices that enable the user to interact with a remote device, such as the host device 106. The host device 106 may be configured as local servers, a serverless system, or a distributed system. In addition, the network 108 may be implemented as a wired or wireless network. The host device 106 may exchange data with computing devices 110 that host an LLM 112 as discussed herein.

The host device 106 may receive a query 114 from the user 102 via the user device 104. The query may be an SQL query or other type of query that extracts user-specified data from a datastore 116 to create a dataset 118 (also referred to as an “actual dataset” or “first dataset”). For example, the user 102 may desire to create a query to extract a dataset that includes a quantity of events over a given time period. The query 114 may include a field for a time/day (i.e., time increment), which in this example may be 30 days, and at least one field for a count of events for the time increment. The time interval may be any increment of time and may include constant intervals on inconsistent intervals between time stamps. In this example, the time increment may be daily (i.e., 24 hours). Thus, the example dataset may include thirty (30) data entries, each having a value that includes a count of an event for a 24 hour period of time. In some embodiments, a user may submit a dataset as a file, a link to data, or in other ways without a query.

The event can be practically any event or action that is recorded with electronic data. An example event is a customer selection (e.g., click) of an item made available on an electronic catalog. When a user selects the item, the host device 106 (or another device) may generate data recording the user action, where the data includes at least a timestamp and a value in a data field. This data may be stored in the data store 116 and queried to create aggregated data as the dataset 118. Later, the user 102 may desire to analyze this data to determine whether any data anomalies exist in the dataset 118. When data anomalies exist, the user 102 may choose to research those data anomalies in the underlying data, for example, to determine a reason for the data anomaly, and possibly take additional actions.

After running the query 114 and reviewing the resulting dataset 118, the user 102 may identify one or more known data anomaly 120 in the dataset. The known data anomaly 120 may be identified by the user 102 based on the user's institutional knowledge, based on research, and/or based on other factors. In some instances, the user 102 may create a simulated data anomaly and inset the simulated data anomaly into the dataset 118 (or associate the simulated data anomaly with the dataset 118) to create the known data anomaly 120. This “planting” of a known data anomaly may enable the LLM 112 to better detect data anomalies as discussed below.

In some embodiments, the user 102 may select one or more algorithms 122 that create a reference dataset used for comparison with the dataset 118 to determine the data anomalies. The algorithms 122 may generate data having a pattern similar to a pattern of the data in the dataset 118, such as a linear pattern, a regression pattern, a random pattern, a seasonal pattern, a weighted pattern, or other patterns discussed herein or commonly used in data modeling.

The host device 106 may send data and instructions 124 to the LLM 112 executed by the computing devices 110 for determination of one or more thresholds 126 and possibly other configuration data, which may be returned to the host device 106 from the computing devices 110. The thresholds 126 may be used to identify data anomalies in the dataset 118 or in a future dataset generated by a future execution of the query 114 or a similar query. The LLM 112 may compare the dataset 118 to a reference dataset, which is created from the algorithm(s) 122, to determine deviations in data points for given time stamps. The LLM 112 may then generate thresholds used to select certain deviations as indicators of data anomalies. The LLM 112 may use the known anomaly 120 in the process to verify that the known anomalies are identified for a selected threshold. For example, if a threshold is too high, some known anomalies may be missed or otherwise not detected since they may fall within the threshold and be classified as expected data (not anomalies). If the threshold is too low, the result may include a lot of noise (i.e., false positives), which may distract the user 102 from finding actual data anomalies. In some instances, the LLM 112 may implement an iterative approach to determine the thresholds, which may include setting a threshold, sending the threshold to the host device 106 for interaction by the user 102, and receiving confirmation of another data anomaly (e.g., another known anomaly), which can be used by the LLM 112 to refine the threshold and/or other configuration data to enable better detection of anomalies (e.g., with less noise, etc.).

In some embodiments, the LLM 112 may determine the one or more algorithms 122 rather than receiving the algorithm(s) from the host device 106. For example, the instructions 124 may request the LLM 112 to determine the one or more algorithms from a collection of possible algorithms that model or fit the dataset 118 provided to the LLM 112. In some instance, the LLM 112 may omit or otherwise exclude the known data anomalies 120 when selecting the one or more algorithms 122 so that the known data anomalies 120 do not influence or skew creation of the reference dataset of data points created by the algorithm that is selected.

Ultimately, the computing devices 110 of the LLM 112 may send at least the threshold(s) 126 to the host device 106, possibly with other configuration data. In some embodiments, the LLM 112 may send the algorithm(s) 122 to the host device 106 when the LLM 112 selects the algorithm(s).

The host device 106 may include an anomaly detection application 128, which may receive the query 114, the algorithm(s) 122, the threshold(s) 126, and/or other possible configuration data. The anomaly detection application 128 may determine data anomalies in a dataset (possibly a new dataset) returned by the query 114, using the algorithm(s) 122 and threshold(s) 126. For example, the query may be modified to change time constraints or other parameters to return different data than the data in the dataset 118, while retaining the structure of the data fields, etc. In some instances, when the query returns a dataset with multiple fields of data to be analyzed (referred to herein as “multi-dimensional data”), then the anomaly detection application 128 may utilize different algorithms and thresholds for different dimensions of the data. The anomaly detection application 128 may output detected anomalies in the dataset after applying the algorithm(s) 122 and the threshold(s) 126. The user 102 may then research the detected anomalies 130, which should include the known anomaly 120, to determine a reason for the anomaly and to possibly take corrective action or other actions as needed.

Over time, the process described above may be repeated as new data is obtained in the data store 116 and additional anomalies are detected using the process described above. For example, after running the process a first time and obtaining the detected anomalies 130, at least some of those anomalies may be provided to the LLM 112 as the known anomalies 120 in a subsequent process to refresh the algorithm(s) 122, the threshold(s) 126, and/or other configuration data.

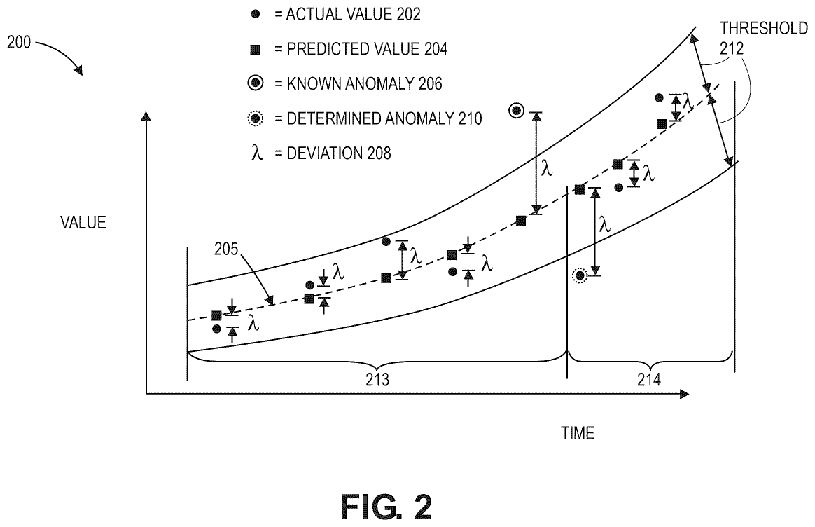

FIG. 2 is a pictorial diagram showing exemplary data 200 including a first dataset having a known anomaly and a second dataset to detect additional anomalies, in accordance with aspects of the disclosed subject matter. The data 200 may be time-series data that include a time stamp and at least one value. The data 200 is shown as being plotted by time and value as shown in FIG. 2.

The data 200 illustrates example data points 202 that reflect actual values of the dataset generated by running a query, such as the query 114 described with reference to FIG. 1. The data 200 also illustrates example reference data points 204 that reflect predicted or reference values of the dataset generated by running an algorithm, such as the algorithm 122 described with reference to FIG. 1. The algorithm may generate the reference data points 204 along a reference line 205, which may be a line or curve fit for the data points 202, based on a data pattern (e.g., seasonal, regression, random, weighted, etc.), or created in other ways to predict locations of the data points 202.

One or more known anomaly 206 (e.g., the known anomaly 120 from FIG. 1) is illustrated in the data 200. The known anomaly 206 may be identified by a user (e.g., an analyst) and indicated in the data 200. For example, from prior research, the user may be aware of one or more known data anomalies and may indicate a time associated with each known data anomaly. As discussed above, a simulated data point may be planted in the dataset to act as a known anomaly.

The data 200 illustrates a deviation 208 which is a difference between the data point 202 and the reference data point 204 at a given time. The deviation 208 may be evaluated as an absolute value to indicate a magnitude of the difference between the data point 202 and the reference data point 204. Each data point may have a different deviation from a corresponding reference data point. Ultimately, the deviation 208 may be used to identify data anomalies as data points that exceed a threshold 212 for the deviation. The threshold 212 may be expressed as a percentage, an actual value, stepwise values, using statistical deviations, or possibly in other ways. A determined data anomaly 210 is illustrated in the data 200 as being determined using the anomaly detection application 128 referenced in FIG. 1 to identify one or more additional data anomaly in a dataset created by the query. In an example implementation, the data points 202 for a first time period 213 may be used to create the algorithm, the reference dataset, the deviations, and/or the threshold(s). The query may then be used to obtain additional data for a second time period 214, where the anomaly detection application 128 may identify the determined data anomaly 210.

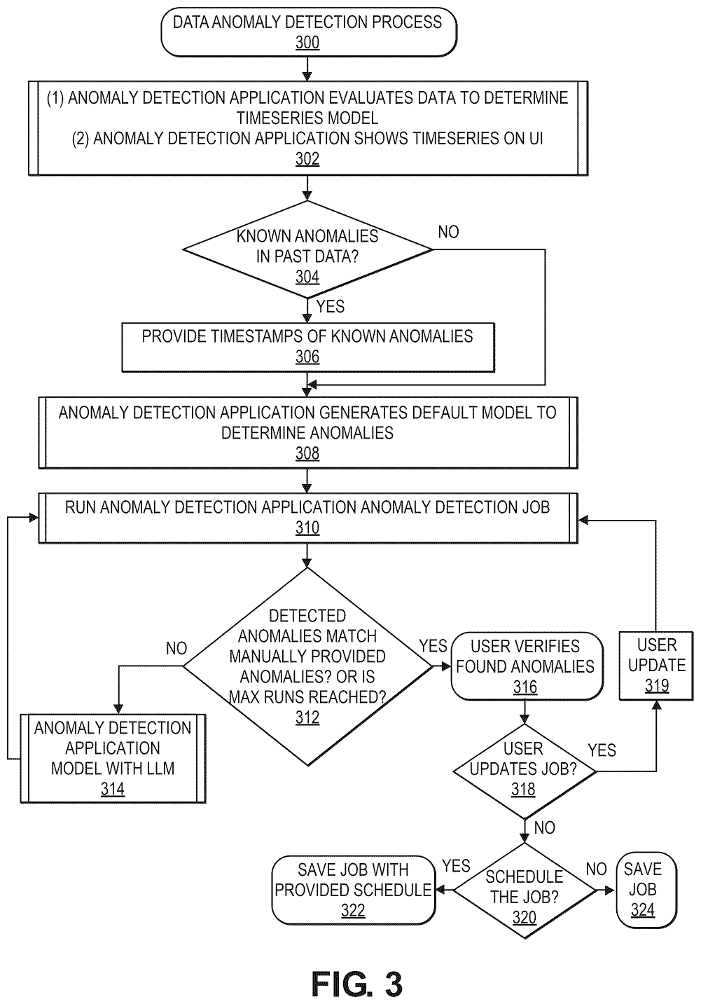

FIG. 3 is a flow diagram illustrating an exemplary process 300 for detection of data anomalies, in accordance with aspects of the disclosed subject matter. The example process of FIG. 3 and each of the other processes and sub-processes discussed herein may be implemented in hardware, software, or a combination thereof. In the context of software, the described operations represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMS, EEPROMs, flash memory, magnetic or optical cards, solid-state memory devices, or other types of storage media suitable for storing electronic instructions. In addition, in some implementations, the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation and any number of the described operations can be combined in any order and/or in parallel to implement the routine. Likewise, one or more of the operations may be considered optional. Various operations from different processes may be combined in accordance with various embodiments.

The process 300 may begin by running a query to evaluate data for a time series model which can be provided or plotted on a user interface for review by a user, as in 302. The query may be executed using any appropriate application and may be executed by the data anomaly application 128 referenced in FIG. 1. The data anomaly application 128 may update the query to a format used by the application, such as to replace start and end times with placeholders, determine time interval, and other possible updates or configurations. The data anomaly application 128 may then execute the query and analyze the results for the dimensions of data values and time series included in the dataset generated in response to executing the query. For example, the data may include the following example information shown in Table 1.

TABLE 1

| Time Stamp | Count | Device | . . . | Value N |
|---|---|---|---|---|
| May 1, 2024 | 121 | iPhone | . . . | Value_1 |
| May 1, 2024 | 148 | Android | . . . | Value_2 |
| May 2, 2024 | 98 | iPhone | | Value_3 |
| May 2, 2024 | 111 | Android | . . . | Value_Y |

Table 1 shows illustrative fields of a time stamp which can be any time in consistent or inconsistent increments of second, minutes, hours, days, weeks, months, years, etc. Table 1 also shows multiple dimensions of data, such as a count, a device, . . . , and a value N. In this example, the time stamp may be generated for each unique grouping of the device (e.g., iPhone or Android), thus there are two records for each unique time stamp. In one-dimensional datasets, there may only be a single record for each unique time stamp and a count.

After running the query to produce the dataset, which may be depicted in a graphical representation such as that shown in FIG. 2, the process 200 may advance to a decision as to whether anomalies are known in the data, as in 304. The known anomalies may be identified by a user through inspection of the data using a manual process or other processes. When anomalies are known, the process 300 may advance along the “yes” route from the decision operation 304 to receive indications of known anomalies, as in 306. For example, the user may select the anomalies on a user interface, enter a time stamp of a known anomaly, or designate known anomalies in other ways, at the operation 306.

Following the “no” route from the decision operation 304 or following the operation 306, the anomaly detection application 128 may generate a default model to determine data anomalies. The anomaly detection application 128 may generate the default model by loading configuration data, including the dataset, the reference dataset, thresholds, and/or other available configuration data, as in 308.

The anomaly detection application 128 may run an anomaly detection job, as in 310. Prior to running the anomaly detection job, the anomaly detection application 128 may receive at least a threshold from an LLM as discussed above in order to calibrate or otherwise determine how to select anomalies in the data. The anomaly detection application 128 may run an anomaly detection job by inputting the same query as used in the operation 302. The anomaly detection application 128 may select or receive at least one algorithm (also referred to as a data model, time series model, equation, or reference data) for use in detection of anomalies. The algorithm may include patterns for expected data, such as a seasonal pattern, a linear regression, a polynomial regression pattern, a random pattern, a weighted pattern based on trend or neighboring values, etc., each possibly having multiple lines/curves for each dimension of the data (e.g., such as the dimension of “device” shown in Table 1). Seasonal data may follow trends of a season, which may be weekly trends, trends based on events on a calendar such as holidays and weekends, weather trends (e.g., cold and snowy versus hot and dry), shopping trends, user activity trends, etc. Additional patterns may be used or implemented by the algorithm. The algorithm may avoid using best fit or overfit of reference data since this type of data may be poor at predicting or forecasting other data points when a time range for the query is expanded or changed, for example.

The anomaly detection application 128 may determine whether detected anomalies from the operation 310 match the known anomalies identified at the operation 306 (if any) and/or may determine if a maximum number of runs has occurred, as in 312. In some instances, the detected anomalies may not exactly match a time stamp of a known anomaly but may be close to the time stamp of a known anomaly and thus closely match the known anomaly. When the detected anomalies do not match or closely match the known anomalies (within a predetermined range of time stamps from the known anomalies) or when max runs is not reached, then the process 300 may advance to an operation 314 following the “no” route from the operation 312.

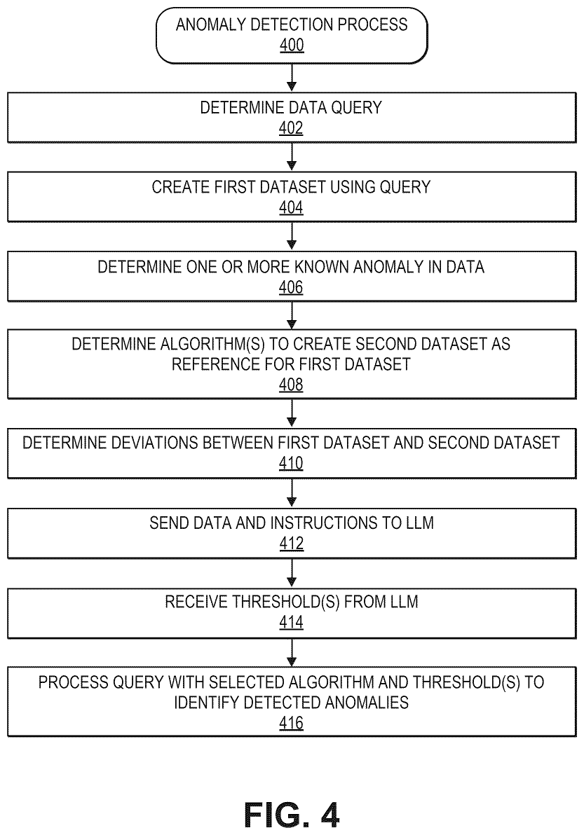

The anomaly detection application 128 may update the model with data from the LLM to update at least thresholds used to detect the data anomalies, as in 314. As described above, and in more detail in FIGS. 4-7 below, the LLM may provide information (e.g., configuration data, etc.) to update the anomaly detection application 128 to enable better detection of anomalies (e.g., fewer false positives, less noise, etc.). As an example, the LLM may be provided with input data such as the dataset, the query, an algorithm, and possibly one or more known anomalies, and may output a threshold and possibly other configuration data for use in updating or configurating the anomaly detection application to enable detection of the additional anomalies. Following the operation 314, the process 300 may return to the operation 310 and continue processing accordingly.

When the detected anomalies match or closely match the known anomalies or the maximum runs have been reached at the decision operation 312, then the process 300 may advance along the “yes” route to an operation 316. The found anomalies may be presented to a user to verify the found anomalies, as in 316. For example, the found anomalies may be provided in a user interface and designated as possible anomalies for research or verification.

The anomaly detection application 128 may determine whether to update the configuration data and/or other inputs to the anomaly detection application 128 based on verified detected anomalies, such as to modify the threshold(s), as in 318. When the anomaly detection application 128 is to be updated by the user following the “yes” route from the decision operation 318, the update may be implanted, as in 319, and processing may continue at the operation 310 as described above.

In various embodiments, a confidence score and/or a noise score may be calculated for detected anomalies. For example, for each dimension which includes expected anomalies, a user or application can calculate a confidence score and/or a noise score. The confidence score may provide information about accuracy of matched anomalies and may be calculated using example Equation 1, shown below.

$$confidenceScore = \frac{\sum \frac{maxAllowedDistance - actualDistance + 1}{maxAllowedDistance + 1}}{numberOfExpectedAnomalies} \qquad Equation l$$

In an example, a first detected anomaly may be found with a distance of two time-increments or time stamps from a time stamp of a known anomaly. A second detected anomaly may be detected at a same time stamp as a known anomaly. The confidence score may be calculated as (25%+100%)/2=62.5% in this example. If a third detected anomaly is produced but did not identify any match within max allowed distance, the score may drop to (25%+100%)/3=41.7%, in this example. Other techniques may be used to generate a confidence score that represents whether a detected anomaly corresponds to known anomalies. The confidence score may be used to determine whether the inputs to the LLM are correct (e.g., is the algorithm correct, etc.), whether the thresholds are correct, or for other troubleshooting to improve the anomaly detection algorithm 120.

As a secondary parameter, the process may determine a noise score, which may be calculated using example Equation 2, as shown below to provide details on how much noise (e.g., false positives, etc.) are included in the detected anomalies based on the selected algorithm(s). When deciding which algorithm to select, first the confidence score may be considered. The configuration of an algorithm with a highest confidence may be selected. If multiple configurations show the same score, an algorithm with the lowest noise may be selected. As the noise score may be implemented as a secondary trigger, it is not required to account for the difference of valid versus unexpected anomalies.

$$noiseScore = \frac{numberOfIdentifiedAnomalies}{totalNumberOfTimestamps} \qquad Equation 2$$

In various embodiments, the input query may contain a list of dimensions, but there is no guarantee that the data will have at least one expected anomaly for each of the dimension combinations. This means there will be no confidence score which can be used to rate the results. However, results can still be evaluated and/or selected using the noise score.

In various embodiments, when no known anomalies are input at the operation 306, the process 300 may be run through at least a single iteration of anomaly detection and a threshold may be applied to identify no more than a predetermined amount or percentage of data points as detected anomalies, such as less than 10%, less than 5%, etc. to avoid providing excess false positives or noisy data.

When no updates are performed on the model following the “no” route from the decision operation 318, then a decision on whether to schedule a job may occur, as in 320. When a job is to be scheduled following the “yes” route from the decision operation 320, then the job may be saved and scheduled, as in 322. The job may be an updated query for a range of data (e.g., range of time stamps, etc.) using the configuration determined from the operations 310 to 319 as described above. The scheduling and running of the job by the anomaly detection application 128 may result in detection of additional anomalies that may be presented to the user and processed accordingly (e.g., researched, validated, confirmed, etc.). When a job is not to be scheduled, following the “no” route from the decision operation 320, then the job may be saved, as in 324, and possibly executed or run at a later time.

FIG. 4 is a flow diagram illustrating an exemplary process 400 for data anomaly detection using an LLM, in accordance with aspects of the disclosed subject matter. The process 400 may begin by determining a query to create a dataset, as in 402. The query may be an SQL query to extract structured data from a data store, such as the data store 116 shown in FIG. 1. However, other types of queries may be determined and/or created to extract data from a data source. The query may extract time-series data having a field for a time value and at least one field for a value, such as a count of occurrences of an event. However, other types of data may be queried that do not have time as a field in the data.

A first dataset may be created in response to executing the query, as in 404. The first dataset may include single dimensional data having fields of at least time and value (e.g., count). However, the first dataset may include multiple dimensional data and include fields of data such as device type, location, or virtually any other metric.

The dataset may be provided for inspection by a user or possibly by software to determine one or more known anomaly, as in 406. For example, the dataset may be plotted in a user interface as data points in relation to time. A user may inspect the data points, perform research and/or other tasks, and identify one or more known anomalies in the dataset. In some embodiments, simulated anomalies may be planted or injected into the dataset (or associated with the dataset) to create known anomalies. For example, the user or software may create or modify an actual data point with simulated data to create an anomaly which may be used for selection of the algorithm and/or to test configurations of an anomaly detection application created using the process 400. In various embodiments, no known anomalies may be present. However, after determination of an algorithm as discussed below, anomalies may be identified based on a comparison of the first dataset and a second dataset generated by the algorithm.

The user or software may determine one or more algorithm that creates a reference dataset of reference data points, as in 408. The reference dataset may be compared to the actual dataset to detect anomalies in the actual data points. The algorithm may be selected to “fit” a type of data and may be selected based on a confidence score and/or noise score as discussed above with reference to the process 300. In some embodiments, data points from the first dataset that are known anomalies may be removed or ignored when selecting the one or more algorithm to prevent the known anomaly from skewing or otherwise influencing the selection of the algorithm(s). In various embodiments, the host may send first instructions to the LLM with the first dataset, where the instructions cause the LLM to determine the one or more algorithm. The LLM may then return the one or more algorithm to the host for further processing as discussed below.

Deviations between the first dataset and the second dataset may be determined, as in 410. The deviations may be determined as absolute values, percentage changes, statistical deviations, or using other known techniques to compare first data points of the first dataset to second data points of the second (reference) dataset generated by the algorithm. In various embodiments, the algorithm may provide the deviations directly without output of the second dataset.

Data and instructions may be sent to an LLM, as in 412. The data may include any of the following: the query, the first dataset, the algorithm, the second dataset, the deviations, and/or any known anomalies. The instructions may include natural language instructions that provide steps, context, examples, and/or other data to the LLM to cause the LLM to generate thresholds and possibly other configuration data to enable detection of additional data anomalies, including the known anomaly as a reference data point. In some embodiments, the operation 412 may be a second call to the LLM, such as when the algorithm is provided by the LLM at the operation 408. In such embodiments, the instructions to the LLM may be second instructions and may include one or more anomalies determined based on use of the algorithm, such as by comparison of the first dataset to a second dataset generated by the algorithm.

The LLM may send the threshold(s) and/or other configuration data to the anomaly detection application, as in 414. The anomaly detection application may be configured with any of the following: the query, the first dataset, the algorithm, the second dataset, the deviations, the threshold, other configuration data, and/or any known anomalies. The anomaly detection application may enable selection of parameters for the query, such as a time range for the query to create an update to the dataset or a new dataset.

The anomaly detection application may process the query, algorithm, etc., and apply the thresholds to output one or more detected anomaly, as in 416. The detected anomalies may be identified in a plot of the data points similar to the plot of the data 200 shown in FIG. 2. In some instances, the detected anomalies may be output as data points associated with respective time stamps. The detected anomalies may be output to the user in other ways to enable the user to research the detected anomalies and possibly validate the anomalies or perform other actions in response to detection of anomalies in the dataset.

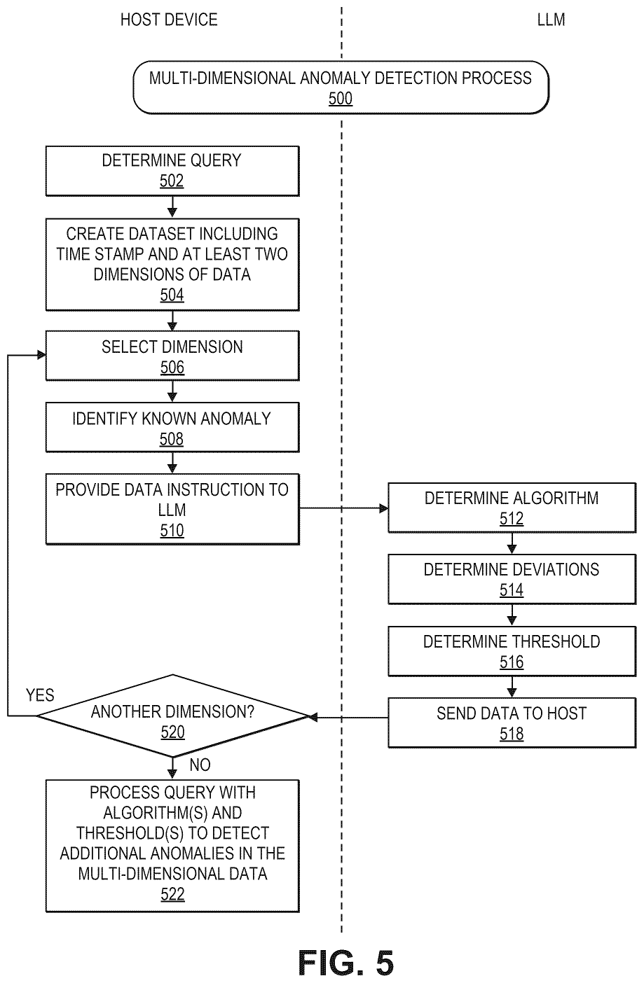

FIG. 5 is a flow diagram illustrating an exemplary process 500 for multi-dimensional data anomaly detection using an LLM, in accordance with aspects of the disclosed subject matter. Some of the operations of the process 500 are shown in association with a device or entity that may perform that operation. However, operations may be performed by other entities or devices in some embodiments.

The process 500 may begin by determining a query to create a dataset having multiple dimensions of data, as in 502. The query may extract time-series data having a field for a time value and at least two fields, where one of the fields may be a count of occurrences of an event.

A first dataset may be created in response to executing the query, as in 504. The first dataset may include multi-dimensional data having fields of at least time and value (e.g., count), and possibly other fields such as device type, location, and so forth. In some instances, the dataset may not include a time value.

A dimension of the data (e.g., a field of values in the dataset) may be selected for processing, as in 506. The dimension may be selected based on user input, an order of the fields, or based on other factors. The dimension may be used for the following operations 508 to 516 as described below.

The dataset having at least the dimension and a time stamp (or other value) may be provided for inspection by a user or possibly by software to determine one or more known anomaly, as in 508. For example, the dataset may be plotted in a user interface as data points in relation to time. A user may inspect the data points, perform research and/or other tasks, and identify one or more known anomalies in the dataset. As discussed above, in some embodiments, simulated anomalies may be planted or injected into the dataset to create known anomalies.

Data and instructions may be provided to the LLM, as in 510. The data may include at least the query or dataset and the one or more known anomaly. The instructions may include natural language instructions that provide steps, context, examples, and/or other data to the LLM to cause the LLM to generate thresholds and possibly other configuration data to enable detection of additional data anomalies, including the known anomaly as a reference data point. In some embodiments, the data instructions may be sent to the LLM as a batch after all dimensions of data are processed in accordance with the operations 506 and 508.

The LLM may determine an algorithm that creates a reference dataset of reference data points, as in 512. The reference dataset may be compared to the actual dataset to detect anomalies in the data points. The algorithm may be selected to “fit” a type of data and may be selected based on a confidence score and/or noise score as discussed above with reference to the process 300. In some embodiments, data points from the first dataset that are known anomalies may be removed or ignored when selecting the algorithm to prevent the known anomaly from skewing or otherwise influencing the selection of the algorithm. In some embodiments, the algorithm may be generated or selected by the user or via the host device.

Deviations between the first dataset and the second dataset created by the algorithm may be determined, as in 514. The deviations may be determined as absolute values, percentage changes, statistical deviations, or using other known techniques to compare first data points of the first dataset to second data points of the second (reference) dataset created by the algorithm determined via the operation 512.

The LLM may generate thresholds for the deviations and possibly other configuration data to enable detection of additional anomalies, as in 516. The LLM may select the threshold(s) such that known anomalies fall outside of the threshold and are thereby indicated as detected anomalies. In some embodiments, the selection of the threshold may include limiting the quantity of detected anomalies to a certain quantity or percentage of the data points of the dataset.

The LLM may send the threshold and/or other configuration data to the anomaly detection application, as in 518. The anomaly detection application may be configured with any of the following: the query, the first dataset, the algorithm, the second dataset, the deviations, the threshold and/or any known anomalies.

The process 500 may determine whether another dimension of data in the dataset is to be processed, as in 520. When another dimension is to be processed, following the “yes” route from the decision operation 520, then the process 500 may advance to the operation 506 and select a different dimension to process, and continue along the process 500 as described above. When no further dimensions are to be processed, following the “no” route from the decision operation 520, then the process may advance to an operation 522.

The anomaly detection application may process the query and apply the thresholds to output one or more detected anomaly, as in 522. The anomaly detection application may enable selection of parameters for the query, such as a time range for the query to create an update to the dataset or a new dataset. The anomaly detection application may apply the thresholds by isolating the data by dimension and may apply the corresponding algorithm/threshold for each dimension. The detected anomalies may be identified in a plot of the data points similar to the plot of the data 200 shown in FIG. 2. In some instances, the detected anomalies may be output as data points associated with respective time stamps. The detected anomalies may be output to the user in other ways to enable the user to research the detected anomalies and possibly validate the anomalies or perform other actions in response to detection of anomalies in the dataset.

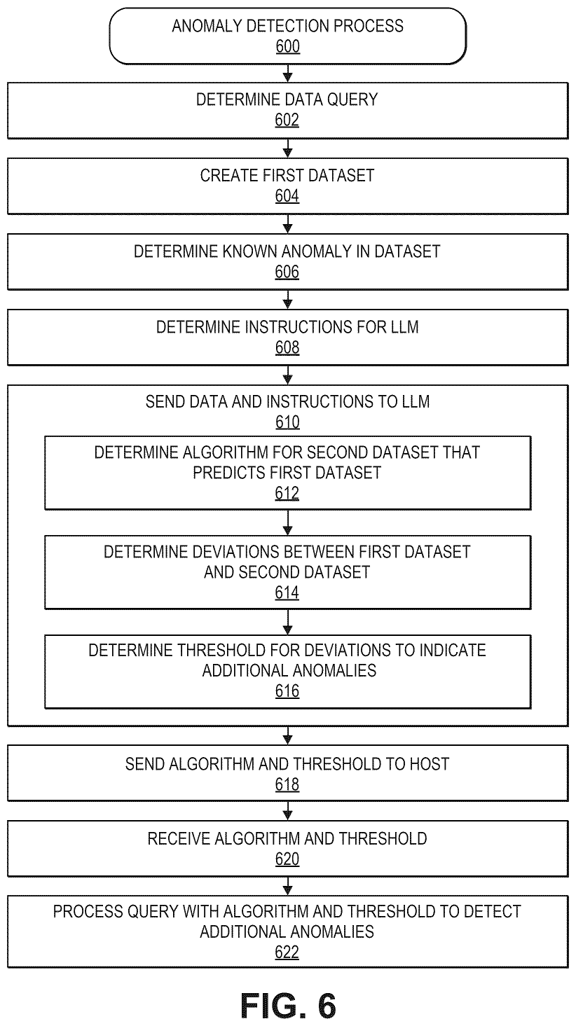

FIG. 6 is a flow diagram illustrating another exemplary process 600 for data anomaly detection using an LLM, in accordance with aspects of the disclosed subject matter. The process 600 may begin by determining a query to create a dataset, as in 602. The query may extract time-series data having a field for a time value and at least one field for a value, such as a count of occurrences of an event. However, other types of data may be queried that do not have time as a field in the data.

A first dataset may be created in response to executing the query, as in 604. The first dataset may include single dimensional data having fields of at least time and value (e.g., count). However, the first dataset may include multiple dimensional data and include fields of data such as device type, location, or virtually any other metric.

The dataset may be provided for inspection by a user or possibly by software to determine one or more known anomaly, as in 606. For example, the dataset may be plotted in a user interface as data points in relation to time. A user may inspect the data points, perform research and/or other tasks, and identify one or more known anomalies in the dataset. In some embodiments, simulated anomalies may be planted or injected into the dataset to create known anomalies. For example, the user or software may create or modify an actual data point with simulated data to create an anomaly which may be used for selection of the algorithm and/or to test configurations of an anomaly detection application created using the process 600.

Instructions may be created or determined to instruct an LLM to create configurations for an anomaly detection application, as in 608. The instructions may include examples, expected output, and/or other information, possibly provided in part in a natural language narrative for processing by the LLM. In some instances, the instructions may be separate from the data, such as the query, dataset, known anomalies, etc. However, the instructions may include the data in some embodiments. The instructions may request the LLM to select one or more algorithms to create the reference dataset as discussed above. The instructions may also request the LLM to create the threshold for indicating anomalies based on a deviation between the first dataset provided to the LLM and the reference dataset generated by the algorithm selected by the LLM. The instructions may cause the LLM to ignore the known anomalies when selecting the algorithm to prevent the known anomaly from skewing or otherwise influencing the selection of the algorithm. The instructions may cause the LLM to output at least the selected algorithm and threshold, among other outputs and configuration data.

The instructions from the operation 608 and the data from the operations 602 to 606 may be sent to the LLM, as in 610. As discussed above, the instructions may be merged or integrated with the data or may be separate from the data. The data may include at least some of the following: the query, the dataset, and the known anomalies.

The LLM may select one or more algorithm to create the reference dataset of reference data points for comparison to the data points of the dataset generated by the query, as in 612. The LLM may process the instructions to determine which algorithms are available for selection (e.g., seasonal pattern, regression pattern, etc.) among other possible instructions. The LLM may be confined to certain algorithms to prevent the LLM from generating an algorithm the overfits the reference data to the dataset, which often results in poor or inaccurate forecasting of future datasets when the query is modified to include a different time series of data, for example.

Deviations between the first dataset and the second dataset may be determined by the LLM, as in 614. The deviations may be determined as absolute values, percentage changes, statistical deviations, or using other known techniques to compare first data points of the first dataset to second data points of the second (reference) dataset.

The LLM may generate thresholds for the deviation to detect additional anomalies, as in 616. The LLM may select the thresholds to include the known anomaly. In some embodiments, the selection of the threshold may include limiting the amount of detected anomalies to a certain quantity or percentage of the data points of the dataset.

The LLM may send the threshold(s), the algorithm(s) and/or other configuration data to the anomaly detection application, as in 618. The anomaly detection application may be configured with any of the following: the query, the first dataset, the algorithm, the second dataset, the deviations, the threshold and/or any known anomalies. The anomaly detection application may enable selection of parameters for the query, such as a time range for the query to create an update to the dataset or a new dataset.

The anomaly detection application receives the data from the LLM, as in 620. The anomaly detection application may process the query and apply the thresholds to output one or more detected anomaly, as in 622. The detected anomalies may be identified in a plot of the data points similar to the plot of the data 200 shown in FIG. 2. In some instances, the detected anomalies may be output as data points associated with respective time stamps. The detected anomalies may be output to the user in other ways to enable the user to research the detected anomalies and possibly validate the anomalies or perform other actions in response to detection of anomalies in the dataset.

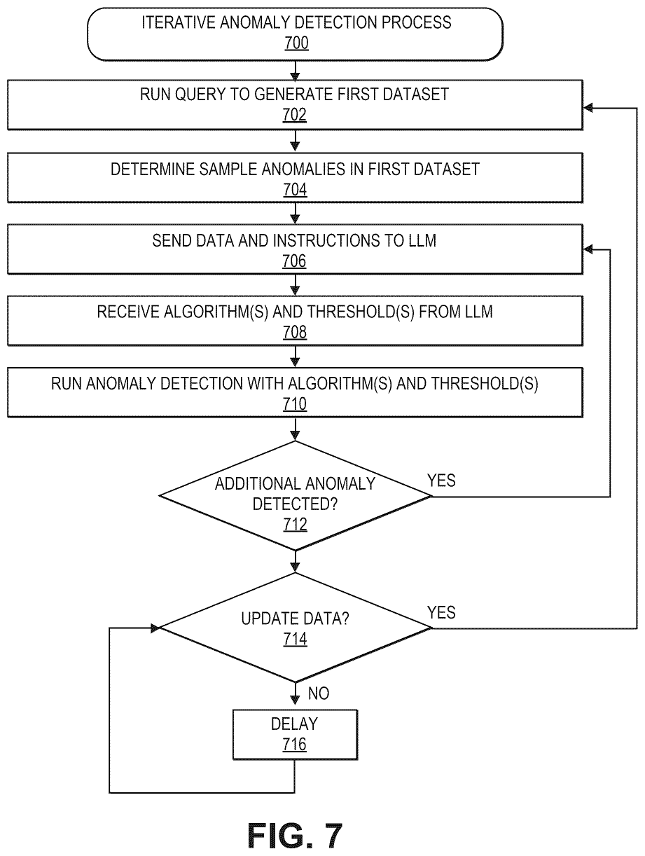

FIG. 7 is a flow diagram illustrating an exemplary process 700 to update data anomaly detection using an LLM, in accordance with aspects of the disclosed subject matter. The process 700 may begin by running a query to create a dataset, as in 702. The dataset may include time-series data and at least one value, such as a count of an event. However, other types of data may be analyzed for anomalies.

The dataset may be provided for inspection by a user or possibly by software to determine one or more known anomaly, as in 704. For example, a user may inspect the data points, perform research and/or other tasks, and identify one or more known anomalies in the dataset. In some embodiments, simulated anomalies may be planted or injected into the dataset to create known anomalies. For example, the user or software may create or modify an actual data point with simulated data to create an anomaly which may be used for selection of the algorithm and/or to test configurations of an anomaly detection application.

Data and instructions may be sent to the LLM for processing to determine a threshold, and possibly an algorithm for anomaly detection, as in 706. For example, operation 706 may be similar to the operation 610 described above with reference to FIG. 6. However, the algorithm may be determined prior to sending data to the LLM, such as described in the process 400 described with reference to FIG. 4.

The LLM may send the threshold and possibly the algorithm and/or other configuration for receipt by the host device, as in 708. The LLM may process information as described above with reference to the process 400 (providing the threshold) or may process information as described above with reference to the process 600 (providing the threshold and the algorithm).

After receipt of the threshold and possibly the algorithm, the anomaly detection application may be configured and executed to detect additional anomalies, as in 710, and such as described above in the operations 416 and 622. A determination whether additional anomalies are detected may be performed, as in 712. When additional anomalies are detected, following the “yes” route from the decision operation 712, then the process 700 may advance to the operation 706 and may use the detected (and verified) anomalies as input data of known anomalies, which may be used to refine and/or update the algorithm, the threshold, and/or other configuration data.

When additional anomalies are not detected, following the “no” route from the decision operation 712, then the process 700 may advance to a decision operation 714. A determination whether to update the dataset may be performed, as in 714. For example, the dataset may be updated by running the query with different time parameters or with other different constraints or parameters to return a different dataset, presumably with the same or similar data fields as including in the dataset from the operation 702. When the data is to be updated, following the “yes” route from the decision operation 714, then the process may advance to the operation 702 to update the dataset. When the data is not to be updated, following the “no” route from the decision operation 714, then the process may advance to an operation 716. The operation 716 may implement a delay and may return to the operation 714 at a later time to determine whether to update the dataset. For example, the delay may be determined by a schedule for running anomaly detection as discussed above with reference to the operation 322 discussed with reference to FIG. 3.

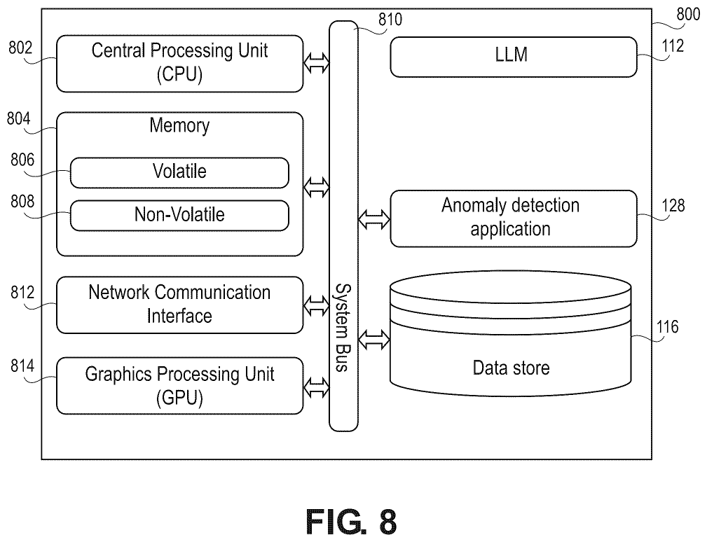

FIG. 8 is a block diagram of an exemplary computing system 800 suitably configured to implement aspects of a host service, in accordance with aspects of the disclosed subject matter. The computer system 800 typically includes one or more central processing units (or CPUs), such as CPU 802, and further includes at least one memory 804. The CPU 802 and memory 804, as well as other components of the computing system, are typically interconnected by way of a system bus 810.

As will be appreciated by those skilled in the art, the memory 804 typically (but not always) comprises both volatile memory 806 and non-volatile memory 808. Volatile memory 806 retains or stores information so long as the memory is supplied with power. In contrast, non-volatile memory 808 can store (or persist) information even when a power supply is not available. In general, RAM and CPU cache memory are examples of volatile memory 806 whereas ROM, solid-state memory devices, memory storage devices, and/or memory cards are examples of non-volatile memory 808.

As will be further appreciated by those skilled in the art, the CPU 802 executes instructions retrieved from the memory 804 from computer-readable media and/or other executable components, in carrying out the various functions of the disclosed subject matter. The CPU 802 may be comprised of any of several available processors, such as single-processor, multi-processor, single-core units, and multi-core units, which are well known in the art.

Further still, the illustrated computer system 800 typically also includes a network communication interface 812 for interconnecting this computing system with other devices, computers and/or services over a computer network, such as network 108 of FIG. 1. The network communication interface 812, sometimes referred to as a network interface card or NIC, communicates over a network using one or more communication protocols via a physical/tangible (e.g., wired, optical fiber, etc.) connection, a wireless connection such as Wi-Fi or Bluetooth communication protocols, NFC, or a combination thereof. As will be readily appreciated by those skilled in the art, a network communication interface, such as network communication interface 812, is typically comprised of hardware and/or firmware components (and may also include or comprise executable software components) that transmit and receive digital and/or analog signals over a transmission medium (i.e., the network 108).

The illustrated computer system 800 also frequently, though not exclusively, includes a graphics processing unit (GPU) 814. As those skilled in the art will appreciate, a GPU is a specialized processing circuit designed to rapidly manipulate and alter memory. Initially designed to accelerate the creation of images in a frame buffer for output to a display, due to their ability to manipulate and process large quantities of memory, GPUs are advantageously applied to training machine learning models and/or neural networks that manipulate large amounts of data, including LLMs and/or the generation of embedding vectors of text terms of an n-gram. One or more GPUs, such as GPU 814, are often viewed as essential processing components of a computing system when conducting machine learning techniques. Also, and according to various implementations, while GPUs are often included in computing systems and available for processing or implementing machine learning models, multiple GPUs are also often deployed as online GPU services or farms and machine learning processing farms.

The computer system 800 may be in communication with or host the anomaly detection application 128 and the data store 116. The computer system 800 may include connectivity to the LLM 112. The data store 116 may be populated by data generated by the computer system 800 and/or by other sources, such as third-party sources that collect data for analysis. In addition, the data store 116 may represent multiple data stores, some possibly populated with data from different sources. The anomaly detection application 128 may provide one or more user interfaces for interaction by a user, such as the user 102 from FIG. 1. The anomaly detection application 128 may include controls to select a query, modify a query, and/or obtain a dataset. The anomaly detection application 128 may facilitate interaction with the LLM 112, such as by sending instructions and data to the LMM 112 and receiving results from the LLM, such as a threshold and other possible configuration data. The anomaly detection application 128 may be configured with the threshold and other data described above to perform data anomaly detection and may output indications of detected anomalies for inspection by a user. The user may then research the detected anomalies to validate the anomalies, determine a cause for the anomalies, or for other reasons.

Regarding the various components of the exemplary computer system 800, those skilled in the art will appreciate that many of these components may be implemented as executable software modules stored in the memory of the computing device, as hardware modules and/or components (including SoCs-system on a chip), or a combination of the two. Indeed, components may be implemented according to various executable implementations including, but not limited to, executable software modules that carry out one or more logical elements of the processes described in this document, or as hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

For purposes of clarity and by way of definition, the term “exemplary,” as used in this document, should be interpreted as serving as an illustration or example of something, and it should not be interpreted as an ideal or leading illustration of that thing. Stylistically, when a word or term is followed by “(s),” the meaning should be interpreted as indicating the singular or the plural form of the word or term, depending on whether there is one instance of the term/item or whether there is one or multiple instances of the term/item. For example, the term “subscriber(s)” should be interpreted as one or more subscribers. Moreover, the use of the combination “and/or” with multiple items should be viewed as meaning either or both items.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method, comprising:
receiving a query that, when executed, extracts a first dataset from a data source, the first dataset including a time stamp associated with at least an actual count of an event;
executing the query to obtain the first dataset;
receiving an indication of at least one time stamp that includes at least one known data anomaly in the first dataset;
analyzing the first dataset to determine an algorithm that calculates a second dataset including second data points that represent a distribution of first data points in the first dataset;
executing the algorithm to generate the second dataset that includes the time stamp associated with at least a predicted count of the event;
determining deviations between the first dataset and the second dataset by comparing the second data points in the second dataset to the first data points in the first dataset to determine a deviation for the event for each time stamp;
determining, using a Large Language Model (LLM), a threshold for the deviations based at least in part on the deviations and the at least one known data anomaly in the first dataset, the threshold indicating additional anomalies in the first dataset; and
creating a data anomaly detector that includes at least the query, the algorithm, and the threshold to determine the additional anomalies in the first dataset.

2. The computer-implemented method of claim 1, wherein:
the analyzing the first dataset to determine an algorithm further includes at least one of:
calculating a confidence score based on a comparison between the first data points of the first dataset and the second data points of the second dataset; or
calculating a noise score indicating an amount of anomalies in the first dataset; and
the determining the algorithm is based at least in part on the confidence score, the noise score, or both.

3. The computer-implemented method of claim 1, wherein:
the analyzing the first dataset to determine the algorithm includes sending the first dataset to the LLM with at least the at least one known data anomaly to determine the algorithm.

4. The computer-implemented method of claim 1, wherein the algorithm is a first algorithm, and further comprising:
determining a second algorithm that calculates a third dataset including third data points that represent the distribution of first data points in the first dataset, the third data points being different than the second data points generated by the second algorithm;
determining second deviations between the first dataset and the third dataset by comparing the third data points in the third dataset to the first data points in the first dataset to determine a second deviation for the event for each time stamp; and
determining, using the LLM, a second threshold for the second deviations based at least in part on the second deviations and the at least one known data anomaly in the first dataset, the second threshold indicating further anomalies in the first dataset.

5. The computer-implemented method of claim 1, wherein:
the threshold is selected to indicate an amount of anomalies as a threshold percentage of the first data points of the first dataset.

6. The computer-implemented method of claim 1, wherein:
the analyzing the first dataset to determine the algorithm includes excluding the at least one known data anomaly from the first dataset when determining the algorithm.

7. The computer-implemented method of claim 1, wherein:
the first data includes data indicating a device type, and
the data anomaly detector determines anomalies by the device type.

8. A computer system, comprising:
one or more processors; and
memory storing program instructions that, when executed by the one or more processors, cause the one or more processors to at least:
receive a first dataset of first data points that include a time stamp associated with at least an actual value for an event;
receive an indication of at least one time stamp that includes at least one known data anomaly in the first dataset;
send at least the first data and the at least one known data anomaly to a Large Language Model (LLM) with instructions that cause the LLM to at least:
determine an algorithm that calculates a second dataset including second data points that represent a predicted value for a distribution of first data points in the first dataset;
determine a threshold for deviations between the first dataset and the second dataset based at least in part on the deviations and the at least one known data anomaly in the first dataset, the threshold indicating additional anomalies in the first dataset; and
receive, from the LLM, at least the algorithm and the threshold; and
determine the additional anomalies in the first dataset using at least the algorithm and the threshold.

9. The computer system of claim 8, wherein the program instructions that when executed by the one or more processors further cause the one or more processors to at least:
include in the instructions a request to exclude a data point with the time stamp associated with the at least one known data anomaly during determination of the algorithm.

10. The computer system of claim 8, wherein the program instructions that when executed by the one or more processors further cause the one or more processors to at least:
include in the instructions a threshold percentage of anomalies to be detected using the deviations and threshold, the threshold percentage to be used by the LLM in part to determine the threshold.

11. The computer system of claim 8, wherein:
the instructions are first instructions, and
the program instructions that when executed by the one or more processors further cause the one or more processors to at least:
send at least the first data and the at least one known data anomaly to the LLM with second instructions that cause the LLM to at least:
determine a second algorithm that calculates a third dataset including third data points that represent the distribution of first data points in the first dataset, the third data points being different than the second data points;
determine second deviations between the first dataset and the third dataset by comparing the third data points in the third dataset to the first data points in the first dataset to determine a second deviation for the event for each time stamp; and
determine a second threshold for the second deviations based at least in part on the second deviations and the at least one known data anomaly in the first dataset, the second threshold indicating further anomalies in the first dataset; and
receive, from the LLM, at least the second algorithm and the second threshold; and
select at least one of the first algorithm or the second algorithm to provide data anomaly detection of the first data.

12. The computer system of claim 8, further comprising:
receiving a simulated data anomaly for association with the first dataset, the simulated data anomaly including a simulated value and being designated as at least part of the at least one known data anomaly.

13. The computer system of claim 8, wherein:
the deviation is expressed as a percentage based on a difference between the predicted value and the actual value for each time stamp.

14. The computer system of claim 8, wherein:
the threshold is selected to indicate a quantity of anomalies as a threshold percentage of the first data points of the first dataset.

15. A method, comprising:
receiving a first dataset of first data points associated with at least an actual value for an event;
sending at least the first data and first instructions to a Large Language Model (LLM), the first instructions including at least:
determining an algorithm that calculates a second dataset including second data points that represent a predicted value for a distribution of first data points in the first dataset;
receiving, from the LLM, at least the algorithm;
determining at least one data anomaly in the first dataset based at least in part on a comparison between the first dataset and the second dataset;
sending at least the first data, an indication of the at least one data anomaly, and second instructions to a Large Language Model (LLM), the second instructions including at least:
determining a threshold for deviations between the first dataset and the second dataset based at least in part on the deviations and the indication of the at least one data anomaly in the first dataset, the threshold indicating additional anomalies in the first dataset;
receiving, from the LLM, the threshold;
determining the additional anomalies in the first dataset using at least the algorithm and the threshold.

16. The method of claim 15, further comprising:
designating at least one of the additional anomalies as a verified data anomaly; and
sending at least the first data, the verified data anomaly, and additional instructions to the LLM to update at least one of the algorithm or the threshold.

17. The method of claim 15, further comprising:
the first dataset further includes a second actual value for the event;
the first instructions further cause the LLM to group at least some of the first data points based on the second actual value to create the algorithm; and
the second instructions further cause the LLM to group at least some of the first data points based on the second actual value to create the threshold.

18. The method of claim 15, wherein:
the first dataset includes time-series data that includes at least a time stamp and at least one field having a count of an action associated with the event.

19. The method of claim 15, wherein:
The threshold is based on at least one of a statistical deviation or a percentage difference between corresponding instances of the first data points and the second data points.

20. The method of claim 15, wherein the first instructions further include:
causing the LLM to ignore the at least one known data anomaly when determining the algorithm.
